(19) United States
(12) Patent Application Publication
(10) Pub. No.: US 2003/0229547 A1
(43) Pub. Date: Dec. 11, 2003

(54) Video storage medium having read-only and writeable portions

(76) Inventor: Pierre Costa, Austin, TX (US)

Correspondence Address: BRINKS HOFER GILSON & LIONE, P.O. BOX 10395, CHICAGO, IL, 60611, US

(21) Appl. No.: 10/420,350

(22) Filed: Apr. 22, 2003

Related U.S. Application Data
(63) Continuation-in-part of application No. 10/105,086, filed on Mar. 21, 2002.

(51) Int. Cl. G06F 17/60

(52) U.S. Cl. 705/26

(57) ABSTRACT

A storage medium having a read-only portion and a read-writeable portion is provided at a retail store. Stored on the read-only portion is content for a plurality of different versions of a motion picture. After a customer has selected the storage medium at the retail store, data is stored to the read-writeable portion of the storage medium at the retail store to select one of the different versions of the motion picture for playback by the customer. A transaction is performed which permits the storage medium to be removed from the retail store for playback of the version of the motion picture by the customer.

### CROSS REFERENCE TO RELATED APPLICATIONS

The present application is a continuation-in-part of U.S. application Ser. No. 10/105,086, filed Mar. 21, 2002, having Attorney Docket No. 8285/505 (T00388), which is hereby incorporated by reference into the present application.

### BACKGROUND OF THE INVENTION

1. Field of the Invention

The present invention relates to methods of providing multiple versions of video content.

2. Description of the Related Art

The cinema industry currently generates several versions of film content based on different target audiences. Thus, if a digital video disk (DVD) is used as a storage device for the content, several DVDs are generated, where each DVD has stored thereon a single version of the film. This process complicates manufacturing and delivery processes associated with the DVDs.

U.S. Pat. No. 5,691,972 to Tsuga discloses storing a full length movie complete with different versions for different languages and for different ratings systems on a single disk which can be used worldwide. Based on a country identifier and a parental level stored in a playback device, one of the versions is enabled for viewing.

### BRIEF DESCRIPTION OF THE DRAWINGS

The present invention is pointed out with particularity in the appended claims. However, other features are described in the following detailed description in conjunction with the accompanying drawings in which:

FIG. 1 is a flow chart of an embodiment of a method to provide multiple rating selection on stored video content;

FIG. 2 is a block diagram of a system to provide multiple rating selection on stored video content;

FIG. 3 shows a representation of a file structure stored by a storage medium such as a DVD;

FIG. 4 shows a simplified diagram of a DVD in accordance with an embodiment of the present invention; and

FIG. 5 is a magnified depiction of an embodiment of a storage medium having a read-only portion and a read-writeable portion on a single substrate.

### DETAILED DESCRIPTION OF THE PREFERRED EMBODIMENTS

Embodiments of the present invention beneficially use a single disk or an alternative digital medium having a read-only region and a read-writeable region. Stored on the read-only region are different versions of a motion picture, including several differently-rated scenes. At a point of sale or rent, one of the different versions is either selected by a customer or based on a customer's age. A code or play list is burned or otherwise written to the read-writeable region of the disk to enable the customer to play back only the specified version. The read-writeable region, which may be either once-writeable or re-writeable. By mass producing the same disk for all versions of the motion picture, the cost of manufacturing video content is reduced, the cost of storing the disks in stores is reduced, and video content delivery is improved. By enabling one version at the point of sale or rent, viewers are inhibited from viewing undesired content after the disk is removed from the store.

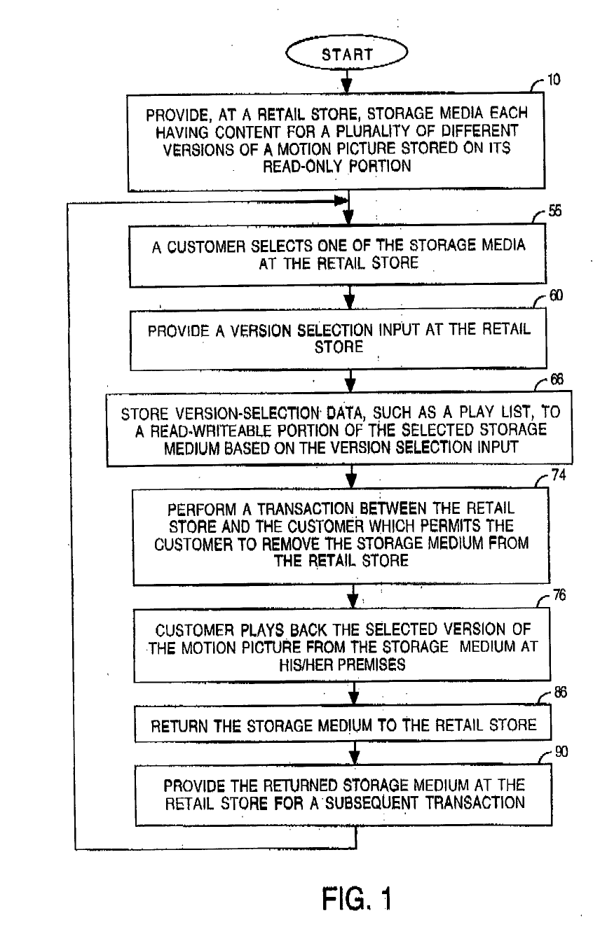

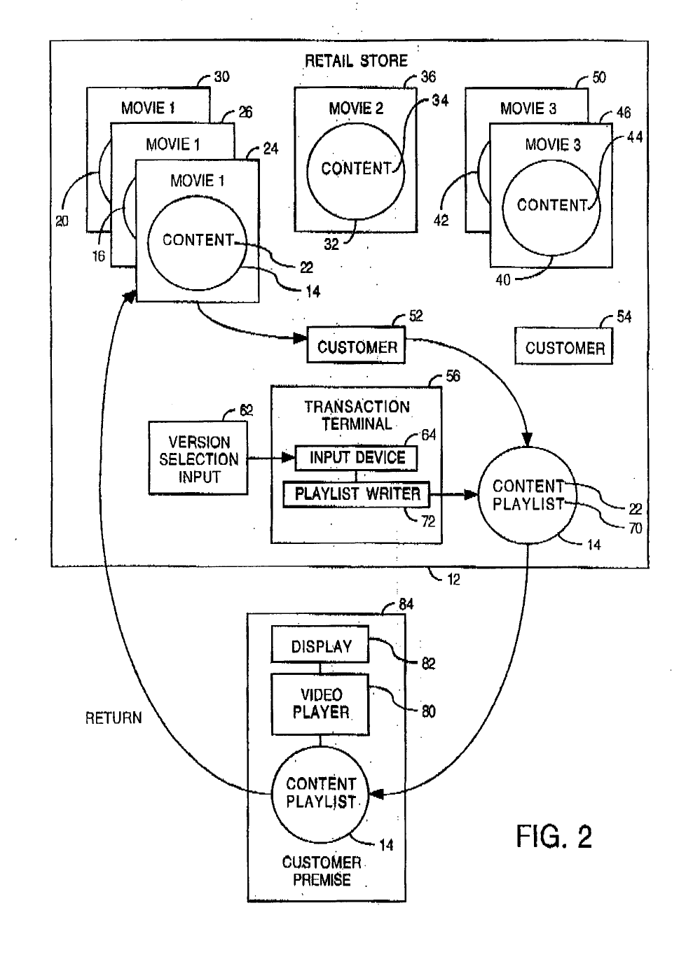

Embodiments of the present invention are described with reference to FIG. 1, which is a flow chart of an embodiment of a method to provide multiple rating selection on stored video content, and FIG. 2, which is a block diagram of an embodiment of a system to provide the multiple rating selection.

As indicated by block 10 in FIG. 1, the method comprises providing, at a retail store 12, storage media each having a read-only portion and a read-writeable portion. Stored on the read-only portion of a storage medium is content for a plurality of different versions of a motion picture. Each storage medium preferably comprises an optical disk such as a DVD. Alternatively, a storage medium may have a non-disk form factor, and/or a non-optical storage medium (e.g. an electronic medium or a magnetic medium). The “motion picture” should be broadly construed as being inclusive of films, movies, pre-recorded television programs, music videos, other videos, and video game content. The different versions of the motion picture may comprise versions having different ratings (e.g. G, PG, PG-13, R or NC-17), or different languages.

The retail store 12 may comprise a video rental store and/or a store at which videos are purchased. For purposes of illustration and example, consider the retail store 12 having storage media 14, 16 and 20 each having stored, on its read-only portion, content 22 for a plurality of different versions of a first motion picture. The storage medium 14 is provided within a container 24, the storage medium 16 is provided within a container 26, and the storage medium 20 is provided within a container 30. Each of the containers 24, 26 and 30 may comprises a DVD container. At least one of the storage medium and the container graphically and/or textually indicates a title of the first motion picture.

Also consider the retail store 12 having a storage medium 32 having stored, on its read-only portion, content 34 for a plurality of different versions of a second motion picture. The storage medium 32 is provided within a container 36, such as a DVD container. At least one of the storage medium 32 and the container 36 graphically and/or textually indicates a title of the second motion picture.

Also consider the retail store 12 having storage media 40 and 42 each having stored, on its read-only portion, content 44 for a plurality of different versions of a third motion picture. The storage medium 40 is provided within a container 46, and the storage medium 42 is provided within a container 50, such as DVD containers. At least one of the storage medium and the container graphically and/or textually indicates a title of the third motion picture.

The various storage media 14, 16, 20, 32, 40 and 42 may be arranged on shelves or bins in the retail store 12. Customers, such as customers 52 and 54, browse the video offerings in the retail store 12. For purposes of illustration and example, consider the customer 52 wishing to view the first motion picture. As indicated by block 55, the customer 52 selects the storage medium 14 having the pre-stored content 22 for different versions of the first motion picture. The customer 52 takes the storage medium 14 within its container 24 to a transaction terminal 56 to conduct a transaction. The transaction may comprise either a purchase of the storage medium 14 or a rental of the storage medium 14. The transaction terminal 56 may comprise either a self-service terminal operable by customers, or a terminal operated by personnel of the retail store 12. Examples of the transaction terminal 56 include, but are not limited to, a point-of-sale terminal and a general purpose computer.

As indicated by block 60, the method comprises providing a version selection input 62. The version selection input 62 is received by an input device 64 of the transaction terminal 56. Examples of the input device 64 include, but are not limited to, a voice input device, a keyboard, a key pad, a touch screen, and a pointing device such as a mouse or a trackball. The version selection input 62 may be provided by either the customer or retail store personnel.

The version selection input 62 indicates one of the different possible versions of the first motion picture. For example, the version selection input 62 may indicate that a PG-13 version of the first motion picture is desired, where the different possible versions also include an R-rated version. In general, the version selection input 62 may indicate an audience rating or a language.

As indicated by block 66, the method comprises storing version-selection data to a read-writeable portion of the storage medium 14. Preferably, the read-writeable portion is rewriteable, although in alternative embodiments the read-writeable portion is once-writeable.

Preferably, the version-selection data comprises a play list 70 which is written to the read-writeable portion of the storage medium 14. The play list 70 is written to the read-writeable portion of the storage medium 14 by a play list writer 72 responsive to the input device 64. Preferably, the play list writer comprises an optical data writer-such as a DVD writer which writes the play list 70. Alternatively, the play list writer may comprise an electronic data writer or a magnetic data writer if either an electronic storage medium or a magnetic storage medium is used. Each storage medium 14, 16, 20, 32, 40 and 42 has a read-writable portion to permit a play list to be written thereto at the retail store 12.

The transaction terminal 56 may have access to stored play lists for each different version of each of the motion pictures offered at the retail store 12. The transaction terminal 56 retrieves one of the play lists based on the selected motion picture and the selected version, and writes the play list to the read-writeable portion of the storage medium.

As indicated by block 74, the method comprises performing a transaction between the retail store 12 and the customer 52. The transaction may comprise either a purchase or a rental of the storage medium 14 by the customer 52. In return for monetary compensation, the customer 52 is permitted to remove the storage medium 14 from the retail store 12. The transaction may be facilitated using the transaction terminal 56. In cases where a purchase is made, having the read-writeable portion be once-writeable is beneficial to mitigate overwriting of the play list. In cases where a rental is made, having the read-writeable portion be re-writeable is beneficial to permit a different play list to be written to the same medium but for a subsequent customer.

As indicated by block 76, the method comprises playback of a first motion picture stored by the storage medium at a customer premise. For example, the customer 52 may have a video player 80, such as a DVD player, and a display 82, such as a television or a monitor, at his/her customer premise 84 (e.g. his/her home). The customer 52 plays back the selected version of the first motion picture stored by the storage medium 14 using the video player 80, and views the selected version using the display 82. In particular, the video player 80 plays back the selected version by reading the play list or alternative version-selection data from the read-writeable portion of the storage medium 14 and the selected content from the read-only portion of the storage medium 14.

Optionally, the method further comprises returning the storage medium to the retail store 12 after the motion picture has been viewed, as indicated by block 86. For example, the customer 52 returns the storage medium 14 to the retail store 12 if the storage medium 14 has been rented. As indicated by block 90, the returned storage medium may be provided at the retail store 12 for a subsequent transaction.

The above acts are repeated for other customers, such as the customer 54, or for the same customer 52 at other times. In one example, the customer 54 may select the storage medium 14 which was returned by the customer 52. The customer 54 may desire a version of the first motion picture (e.g. the R-rated version) which differs from the version selected by the customer 52 (e.g. the PG-13 version). Based on a version selection input received by the input device 64, the play list writer 72 writes version-selection data to the read-writeable portion (which is rewriteable in this case) of the storage medium 14. The version-selection data comprises a play list which differs from the play list 72. The play list may overwrite or otherwise disable the play list 72 selected by the customer 52.

In another example, the customer 54 may select the storage medium 16 in order to view the first motion picture. Based on a version selection input indicating the R-rated version, the play list writer 72 writes version-selection data such as a play list to the read-writeable portion of the storage medium 16.

In a further example, the customer 54 may select the storage medium 32 in order to view the second motion picture. Based on a version selection input received by the input device 64, the play list writer 72 writes version-selection data such as a play list to the read-writeable portion of the storage medium 32.

In all of the three examples, a transaction (e.g. either a purchase or a rental) is performed between the customer 54 and the retail store 12. In return for monetary compensation, the customer 54 is permitted to remove the storage medium from the retail store 12, and playback the selected version of the selected motion picture at his/her customer premise.

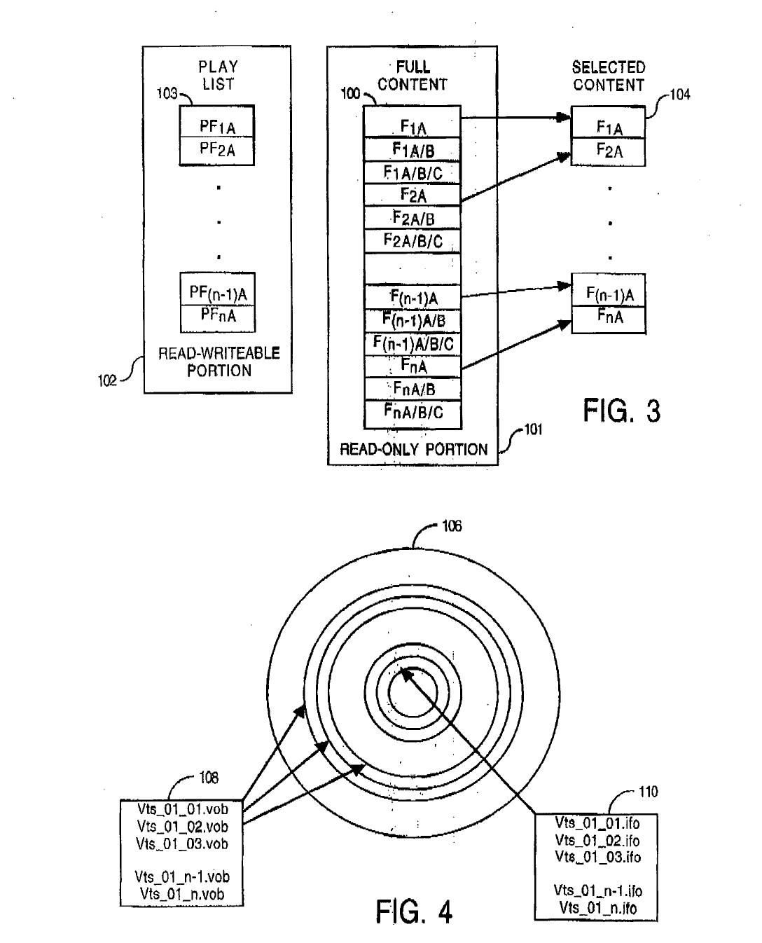

FIG. 3 shows a representation of a file structure stored by a storage medium such as a DVD. The storage medium comprises many content files 100, which include video and audio objects, stored on a read-only portion 101. Examples of the content files 100 include, but are not limited to, MPEG-2 video content, MP2, AC3 or PCM audio content, and options menu content (e.g. trailers). For purposes of illustration and example, three ratings choices A/B/C are considered. Thus, the content files 100 comprise files associated with rating A content, files associated with rating B content, and files associated with rating C content.

The storage medium further comprises a read-writeable portion 102. The storage medium with the content files 100 on the read-only portion 101 and either a blank or a default play list on the read-writeable portion 102 is mass produced for delivery to retail stores.

Consider that a customer selects the storage medium at a retail store, and wishes to view the rating A content. At the retail store, the play list writer writes a play list file 103 to the read-writeable portion 102 of the storage medium. The play list file 103 defines those of the content files 100 which are to be played, and an order in which they are to be played. The play list file 103 shows pointers PFᵢ to those actual content files Fᵢ in the selected version. Thus, the selected content having rating A, indicated by reference number 104, is permitted to be played back by the customer.

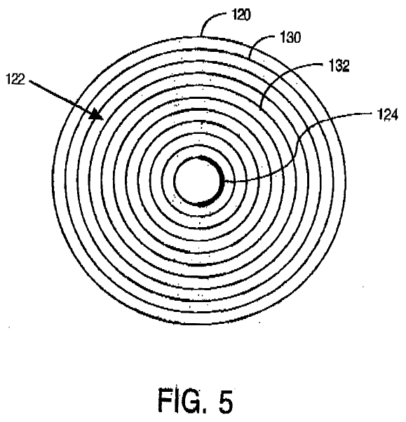

DVD-formatted disks are composed of three major files types: Video Transport Stream files containing Video Objects (VOB), Navigational Information files (IFO), and Backup and Secondary Navigational Information. FIG. 4 shows a simplified diagram of a DVD 106 in accordance with an embodiment of the present invention. The DVD 106 has a read-only portion having stored thereon video content in the form of VOB files 108 for all ratings. For example, three separate sets of rated scenes (e.g. A/B/C in the previous figure) are represented by the three outer tracks shown on the DVD 106. The retail store writes a play list, in the form of one or more IFO files 110, to a read-writeable portion of the DVD 106 to select one of ratings. The IFO file 110, which would be the first file read by a DVD player, is shown on the inner track of the DVD 106.

FIG. 5 is a magnified depiction of an embodiment of a storage medium 120 having a read-only portion 122 and a read-writeable portion 124 on a single substrate. As described herein, the read-only portion 122 is to house multiple versions of content and the read-writeable portion 124 is to enable a play list or an alternative version selection code to be written thereto.

The storage medium 120 has the form of an optical disk with a plurality of tracks located in accordance with a standard format. The optical disk is readable by a standard optical disk reader, such as a DVD reader and/or a CD reader.

Most of the tracks of the storage medium 120 are within to the read-only portion 122. Preferably, no more than one track is in the read-writeable portion 124. In some embodiments, the read-writeable portion 124 consists of a single track. In other embodiments, the read-writeable portion 124 consists of part of a single track. Examples of the form of the read-writeable portion 124 include, but are not limited to: less than or equal to half of the single track (i.e. less than or equal to a 180-degree arc of the single track); less than or equal to a quarter of the single track (i.e. less than or equal to a 90-degree arc of the single track); and less than or equal to an eighth of the single track (i.e. less than or equal to a 45-degree arc of the single track). Excluding the read-writeable part of the single track, a remainder of the single track is part of the read-only portion 122.

The amount of track space dedicated as being read-writeable may be dependent upon the maximum play list size which may be written thereto. For example, a first movie may have a first maximum play list size that differs from a second maximum play list size of a second movie. In this example, the amount of read-writeable track space for a first medium having the first movie may be greater than the amount of read-writeable track space for a second medium having the second movie. Alternatively, the amount of read-writeable track space can be standardized for all movies, i.e. the amount of read-writeable track space for a first medium having the first movie would be equal to the amount of read-writeable track space for a second medium having the second movie. As another alternative, some types of content, such as games, may have more read-writeable track space than other types of content, such as movies.

The read-writeable track may be located at either an inner-most track 126 as depicted, an outer-most track 130 or an interior track 132. The location of the read-writeable track may be selected with consideration to ease of manufacturing the storage medium 120, ease of writing data to the read-writeable portion 124, ease of reading data written to the read-writeable portion 124, and/or whether the storage medium 120 is single-sided or two-sided. For single-sided DVD disks, information is generally read from the inside track out. For double-sided disks, information can be read from the outside track in, to give the read head less distance to move when going from the end of the first side to the beginning of the second side. Standard manufacturing processes can be used to deposit the read-writeable portion 124 to an otherwise read-only medium.

Although current technology allows various types of video content to be included in a medium such as a disk, it is not customary to dynamically and exclusively choose a full-featured film of a particular rating. This disclosure describes a method that allows the selection of a subset of video/audio content for the user or buyer. Thus, only one disk needs to be created, and various versions of the content can be dynamically programmed for viewing. Primary applications include films and video games that can be generated for different age groups and for which an exclusive version can be selected from a superset of video content. This method is applicable to any video/audio content storage delivery that uses a play list and related content files.

It will be apparent to those skilled in the art that the disclosed inventions may be modified in numerous ways and may assume many embodiments other than the preferred forms specifically set out and described herein.

Accordingly, it is intended by the appended claims to cover all modifications which fall within the true spirit and scope of the present invention.

What is claimed is:

1. A method comprising:
providing at a retail store a first storage medium having a read-only portion and a writeable portion, the read-only portion having stored thereon content for a plurality of different versions of a first motion picture;
after a first customer has selected the first storage medium at the retail store, storing data to the writeable portion of the first storage medium to select a first version of the plurality of different versions of the first motion picture for playback by the first customer, said storing the data performed at the retail store; and
performing a transaction which permits the first storage medium to be removed from the retail store for playback of the first version of the first motion picture by the first customer.

2. The method of claim 1 wherein the transaction comprises a purchase of the first storage medium by the first customer.

3. The method of claim 1 wherein the transaction comprises a rental of the first storage medium by the first customer.

4. The method of claim 3 further comprising after the first storage medium has been returned to the retail store by the first customer:
providing the first storage medium at the retail store for a subsequent transaction;
after a second customer has selected the first storage medium at the retail store, storing data to the writeable portion of the first storage medium to select a second version of the plurality of different versions of the first motion picture for playback by the second customer, said storing the data performed at the retail store; and
performing a transaction which allows the first storage medium to be removed from the retail store for playback of the second version of the first motion picture by the second customer.

5. The method of claim 1 wherein the data comprises a play list file.

6. The method of claim 1 wherein the plurality of different versions of the first motion picture comprises versions having different ratings.

7. The method of claim 1 wherein the first storage medium comprises an optical disk.

8. The method of claim 1 wherein the first storage medium is provided within a container, wherein at least one of the first storage medium and the container visually indicates a title of the first motion picture.

9. The method of claim 1 further comprising:
providing at the retail store a second storage medium having a read-only portion and a writeable portion, the read-only portion having stored thereon content for a plurality of different versions of the first motion picture;
after a second customer has selected the second storage medium at the retail store, storing data to the writeable portion of the second storage medium to select a second version of the plurality of different versions of the first motion picture for playback by the second customer, said storing the data performed at the retail store; and
performing a transaction which permits the second storage medium to be removed from the retail store for playback of the second version of the first motion picture by the second customer.

10. The method of claim 1 further comprising:
providing at the retail store a second storage medium having a read-only portion and a writeable portion, the read-only portion having stored thereon content for a plurality of different versions of a second motion picture;
after a second customer has selected the second storage medium at the retail store, storing data to the writeable portion of the second storage medium to select a first version of the plurality of different versions of the second motion picture for playback by the second customer, said storing the data performed at the retail store; and
performing a transaction which permits the second storage medium to be removed from the retail store for playback of the first version of the second motion picture by the second customer.

11. A method comprising:
providing at a retail store a first optical disk having a read-only portion and a writeable portion, the read-only portion having stored thereon content for a plurality of differently-rated versions of a first motion picture, wherein the first optical disk is provided within a container, wherein at least one of the first optical disk and the container visually indicates a title of the first motion picture;
after a first customer has selected the first optical disk at the retail store, storing a first play list to the writeable portion of the first optical disk to select a first version of the plurality of different versions of the first motion picture for playback by the first customer, said storing the first play list performed at the retail store; and
performing a transaction which permits the first optical disk to be removed from the retail store for playback of the first version of the first motion picture by the first customer.

12. The method of claim 11 wherein the transaction comprises a purchase of the first optical disk by the first customer.

13. The method of claim 11 wherein the transaction comprises a rental of the first optical disk by the first customer.

14. The method of claim 13 further comprising after the first optical disk has been returned to the retail store by the first customer:
providing the first optical disk at the retail store for a subsequent transaction;
after a second customer has selected the first optical disk at the retail store, storing a second play list to the writeable portion of the first optical disk to select a second version of the plurality of different versions of the first motion picture for playback by the second customer, said storing the second play list performed at the retail store, the second play list differing from the first play list; and
performing a transaction which allows the first optical disk to be removed from the retail store for playback of the second version of the first motion picture by the second customer.

15. The method of claim 11 further comprising:
providing at the retail store a second optical disk having a read-only portion and a writeable portion, the read-only portion having stored thereon content for a plurality of different versions of the first motion picture;
after a second customer has selected the second optical disk at the retail store, storing a second play list to the writeable portion of the second optical disk to select a second version of the plurality of different versions of the first motion picture for playback by the second customer, said storing the second play list performed at the retail store; and
performing a transaction which permits the second optical disk to be removed from the retail store for playback of the second version of the first motion picture by the second customer.

16. The method of claim 11 further comprising:
providing at the retail store a second optical disk having a read-only portion and a writeable portion, the read-only portion having stored thereon content for a plurality of different versions of a second optical disk;
after a second customer has selected the second optical disk at the retail store, storing a play list to the writeable portion of the second optical disk to select a first version of the plurality of different versions of the second motion picture for playback by the second customer, said storing the play list performed at the retail store; and
performing a transaction which permits the second optical disk to be removed from the retail store for playback of the first version of the second motion picture by the second customer.

17. An article comprising:
a storage medium having a read-only portion and a writeable portion, the read-only portion having stored thereon content for a plurality of different versions of a motion picture.

18. The article of claim 17 wherein the storage medium comprises an optical disk.

19. The article of claim 18 wherein the optical disk comprises a DVD.

20. The article of claim 18 wherein the optical disk has a plurality of read-only tracks in the read-only portion, and at most one writeable track in the writeable portion.

21. The article of claim 20 wherein the writeable portion consists of part of a single track.

22. The article of claim 21 wherein the part of the track is less than or equal to half of a track.

23. The article of claim 21 wherein the part of the track is less than or equal to a quarter of a track.

24. The article of claim 21 wherein the part of the track is less than or equal to an eighth of a track.

25. The article of claim 21 wherein a remainder of the single track excluding the part of the single track is part of the read-only portion.

26. The article of claim 21 wherein the single track is an inner-most track of the optical medium.

27. The article of claim 21 wherein the single track is an outer-most track of the optical medium.

28. The article of claim 21 wherein the single track is an interior track of the optical medium.

29. The article of claim 17 wherein the plurality of different versions of the motion picture comprises versions having different ratings.

30. The article of claim 17 wherein the storage medium visually indicates a title of the motion picture.

31. The article of claim 17 wherein the writeable portion is once-writeable.

32. The article of claim 17 wherein the writeable portion is re-writeable.

33. The article of claim 17 wherein the writeable portion is to store a play list written thereto.

34. An article comprising:
an optical disk having a plurality of tracks including a plurality of read-only tracks and a single track having a re-writeable part and a read-only part, the read-only tracks and the read-only part of the single track having stored thereon content for a plurality of different versions of a motion picture, the re-writeable part of the single track to store a play list written thereto.
